(19) United States
(12) Patent Application Publication
(10) Pub. No.: US 2008/0082996 A1
(43) Pub. Date: Apr. 3, 2008

(54) METHOD AND APPARATUS FOR CHANNEL CHANGE OF DIGITAL BROADCASTING RECEIVER

(75) Inventors: Young Jun JEONG, Gumi-si (KR); Jong Kerl Lee, Gumi-si (KR); Jeong Wook Seo, Daegu Metropolitan City (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/854,464

(22) Filed: Sep. 12, 2007

(30) Foreign Application Priority Data
Sep. 29, 2006 (KR) 2006-0096217

(51) Int. Cl. H04N 5/445

(52) U.S. Cl. 725/38

(57) ABSTRACT

Disclosed is a method and apparatus for changing channels of a digital broadcasting receiver, and more particularly, a method and apparatus for reducing a channel change time by previously receiving and buffering digital broadcasting signals of a plurality of channels continuously adjacent to one side of a main channel in a channel change direction. The method of changing channels includes receiving digital broadcasting signals of a main channel and of plurality of channels continuously adjacent to one side of the main channel in a broadcasting mode; and displaying the digital broadcasting signal of the main channel, and buffering and storing the digital broadcasting signals of the plurality of adjacent channels. Therefore, channel changing time can be reduced in a digital change mode.

### PRIORITY

This application claims priority to an application entitled “METHOD AND APPARATUS FOR CHANNEL CHANGE OF DIGITAL BROADCASTING RECEIVER” filed in the Korean Intellectual Property Office on Sep. 29, 2006 and assigned Serial No. 2006-0096217, the contents of which are incorporated herein by reference.

### BACKGROUND OF THE INVENTION

1. Field of the Invention

The present invention relates to a method and apparatus for channel change of a digital broadcasting receiver, and, more particularly, to a method and apparatus for channel change that reduces a channel change time by previously receiving and buffering digital broadcasting signals of a plurality of channels continuously adjacent to one side of a main channel in a channel change direction.

2. Description of the Related Art

A digital broadcasting receiver performs a function of receiving and displaying various digital broadcasting signals. The digital broadcasting signal is a signal that is digitally encoded and modulated the digital broadcasting receiver. For this reason, the digital broadcasting receiver includes a tuner, a broadcasting data demodulator, and a broadcasting data decoder. A digital broadcasting system is divided into a Digital Multimedia Broadcasting (DMB) type and a Digital Video Broadcasting (DVB) type. Digital broadcasting provides a plurality of service channels in one frequency channel, with service channels composed of channels for transmitting a digital broadcasting signal broadcast in a broadcasting station and channels for transmitting program information and broadcasting information.

Digital broadcasting provides many service channels. Accordingly, the digital broadcasting receiver needs to be able to scan desired service channels and select the service channel specified by a user. That is, because digital broadcasting provides many service channels, a channel change should quickly be performed upon channel selection in the digital broadcasting receiver. For example, in a DVB type digital broadcasting receiver, a burst is generally generated every 1 second in a short case and every 3 to 4 seconds in a long case. Accordingly, when the user changes to another service channel while watching a selected service channel (hereinafter referred to as a main channel), the user cannot watch a broadcasting signal until the burst of the new, changed service channel is received. Accordingly, user displeasure arises if the channel change is not quickly performed.

Further, even when digital broadcasting signals of channels adjacent to, i.e. in forward and reverse directions of channel change, the main channel are previously buffered, only a broadcasting signal of one adjacent channel in a channel change direction is stored. Accordingly, if a channel change instruction is continuously input in one direction from the number of the main channel, the channel change speed may not follow an input speed of the channel change instruction.

### SUMMARY OF THE INVENTION

The present invention has been made in an effort to solve the above problems, and an aspect of the present invention is to provide a method and apparatus for reducing a channel change time by previously receiving and buffering digital broadcasting signals of a plurality of channels, each channel of which is adjacent to another of the plurality of channels, adjacent to one side of a main channel in a channel change direction upon changing a channel in a digital broadcasting mode.

In accordance with an aspect of the present invention, the above and other objects are accomplished by a method of channel change of a digital broadcasting receiver, the method including receiving digital broadcasting signals of a main channel and of a plurality of channels continuously adjacent to one side of the main channel in a broadcasting mode; and displaying the digital broadcasting signal of the main channel, and buffering and storing the digital broadcasting signal of the plurality of adjacent channels.

In accordance with another aspect of the present invention, the above and other objects are accomplished by a method of channel change of a digital broadcasting receiver, the method including receiving digital broadcasting signals of a main channel and of channels adjacent to both sides of the main channel in a broadcasting mode; displaying the digital broadcasting signal of the main channel on a screen of a display unit in the digital broadcasting receiver, and buffering and storing the digital broadcasting signals of the channels adjacent to both sides of the main channel; determining whether a channel change instruction is input while the digital broadcasting signal of the main channel is displayed; receiving, if a channel change instruction is input, digital broadcasting signals of a selected channel to which a channel is changed and of a plurality of channels adjacent to one side of the selected channel in a channel change direction; and displaying the digital broadcasting signal of the selected channel on the screen of the display unit, and buffering and storing the digital broadcasting signal of the plurality of adjacent channels.

In accordance with another aspect of the present invention, the above and other objects are accomplished by an apparatus for channel change of a digital broadcasting receiver, the apparatus including a channel change determining unit for determining whether a channel change instruction is input in a broadcasting mode; and a channel change controller for controlling to receive digital broadcasting signals of a selected channel according to a channel change and of a plurality of channels adjacent to one side of the selected channel in a channel change direction, display the digital broadcasting signal of the selected channel on a screen of a display unit in the digital broadcasting receiver, and buffer digital broadcasting signals of the plurality of adjacent channels.

### BRIEF DESCRIPTION OF THE DRAWINGS

The above and other objects, features and advantages of the present invention will be more apparent from the following detailed description in conjunction with the accompanying drawings, in which:

FIG. 1 is a block diagram illustrating a configuration of a digital broadcasting receiver according to the present invention;

FIGS. 2A-2F illustrate a data structure of a DVB-H type service channel received in a digital broadcasting receiver;

FIG. 3 illustrates an example of a structure of service channel data using a time slicing technique;

FIG. 4 is a flowchart illustrating a method of channel change of a digital broadcasting receiver according to the present invention; and

FIG. 5 is a flowchart illustrating a method of channel change of a digital broadcasting receiver according to another embodiment of the present invention.

### DETAILED DESCRIPTION OF THE PREFERRED EMBODIMENTS

Preferred embodiments of the present invention are described in detail with reference to the accompanying drawings. The same reference numbers are used throughout the drawings to refer to the same or like parts. Detailed descriptions of well-known functions and structures incorporated herein are omitted to avoid obscuring the subject matter of the present invention.

A digital broadcasting receiver according to the present invention has a digital broadcasting receiving function, and those of skill in the art will recognize that the receiver may have other functions such as a mobile communication function, a photographing function and an information processing functions.

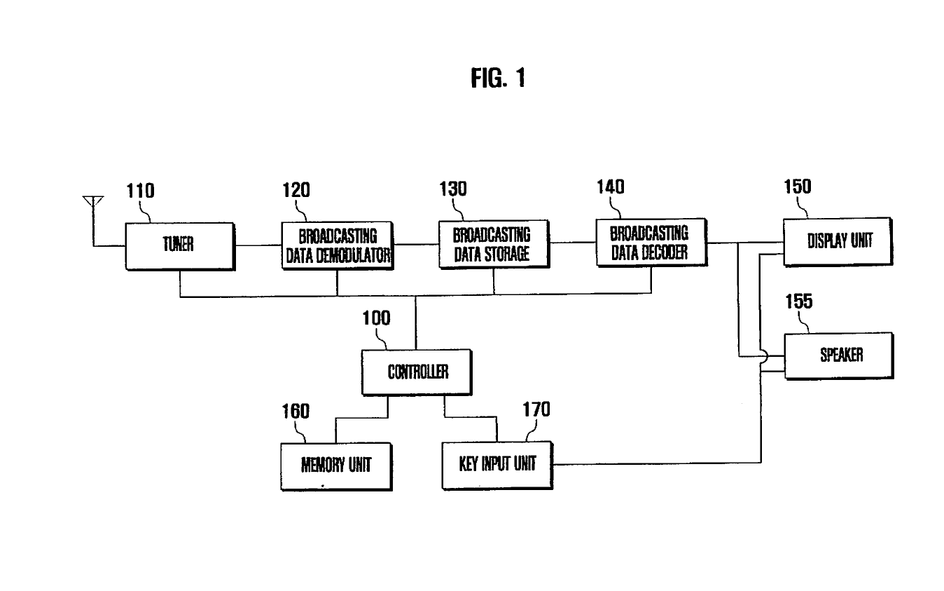

FIG. 1 is a block diagram illustrating a configuration of a digital broadcasting receiver according to the present invention.

For conciseness, the digital broadcasting receiver in FIG. 1 is a DVB-H (DVB-Handheld) type digital broadcasting receiver, although the invention is not so limited.

The digital broadcasting receiver includes a controller 100, tuner 110, broadcasting data demodulator 120, broadcasting data storage 130, broadcasting data decoder 140, display unit 150, speaker 155, memory unit 160, and key input unit 170.

The controller 100 controls the entire operation of the digital broadcasting receiver. The key input unit 170 inputs key data from user input to the controller 100. Particularly, the key input unit 170 has a channel up/down key for sequentially increasing or decreasing a channel number of a main channel. User instruction input via the key input unit 170 may include selection, change and play of a service channel.

The controller 100 has a channel change determining unit for determining whether a channel change instruction key is input in a broadcasting mode. Further, the controller 100 includes a channel change controller for controlling processing of digital broadcasting signals of a selected channel according to the channel change and of a plurality of channels adjacent to the selected channel in a channel change direction, displaying of the digital broadcasting signal of the selected channel on a screen of a display unit in the digital broadcasting receiver, and buffering and temporarily storing digital broadcasting signals of the plurality of adjacent channels in the broadcasting data storage 130.

The memory unit 160 includes a program memory that stores a program for controlling operation of a digital broadcasting receiver and a data memory that stores data generated while executing the program. The program memory has a program for performing a buffering operation for changing a service channel. The controller 100 analyzes key data generated in the key input unit 170 and controls the operation of the digital broadcasting receiver. That is, the controller 100 controls an operation mode (play, record, channel selection, and change) of the digital broadcasting receiver according to user selection.

The tuner 110 sets a frequency of a physical channel corresponding to a service channel selected by the user under the control of the controller 100 and receives a broadcasting signal of the set physical channel. The broadcasting data demodulator 120 performs a function of demodulating the physical channel broadcasting signal output from the tuner 110. The broadcasting data demodulator 120 demodulates and outputs signals of a plurality of service channels included in the physical channel. The broadcasting data storage 130 buffers selected service channel data among service channel data output from the broadcasting data demodulator 120 and unselected service channel data to be used for changing the service channel under the control of the controller 100. The broadcasting data decoder 140 decodes and outputs service channel data corresponding to user selection. The broadcasting data decoder 140 is preferably composed of video and audio decoders, and decoded video and audio signals are output to the display unit 150 and speaker 155, respectively, and played therein.

The broadcasting data demodulator 120 and broadcasting data decoder 140 may alternatively be provided according to a digital broadcasting system. The digital broadcasting receiver is divided into a DMB type and DVB type, and the DVB type includes a Digital Video Broadcasting-Terrestrial (DVB-T) type and Digital Video Broadcasting-Handheld (DVB-H) type. Broadcasting data received in the DMB and DVB type digital broadcasting receiver have a Moving Picture Experts Group2 Transport Stream (MPEG2-TS) structure. The broadcasting data of the MPEG2-TS structure are packet stream, and each packet is composed of a packet header and payload. The packet header includes Packet IDentifier (PID) information for identifying a service channel, and the digital broadcasting receiver can select a desired service channel using the PID information.

In the DMB and DVB-T type digital broadcasting receiver, a payload of each packet having an MPEG2-TS structure is filled with broadcasting data, and in the DVB-H type digital broadcasting receiver, a payload of each packet having an MPEG2-TS structure is filled with Internet Protocol (IP) information and broadcasting data. Accordingly, in the DVB-T and DMB type digital broadcasting receiver, the broadcasting data demodulator is a demodulator for demodulating service channel data, and the broadcasting data decoder includes a demultiplexer for decoding a signal of a selected service channel, and video and audio decoders. However, in the DVB-H type digital broadcasting receiver, the broadcasting data demodulator 120 includes a demodulator for demodulating data of a received service channel, a PID filter for selecting data of a service channel selected by a user among the demodulated broadcasting data, and a demodulating controller for controlling the operation of the demodulator and tuner 110 under the control of the controller 100. The broadcasting data decoder 140 includes a protocol processor for processing a protocol including IP information and video and audio decoders.

In a digital broadcasting receiver according to the present invention, when a channel change instruction is received through channel up/down key selection for sequentially increasing or decreasing a channel number in a broadcasting mode, the digital broadcasting receiver receives digital broadcasting signals of a selected channel from which the channel is changed by the channel change instruction and of a plurality of channels continuously adjacent to one selected channel in a channel change direction, displays the digital broadcasting signal of the selected channel, and buffers digital broadcasting signals of channels adjacent to the main channel. Accordingly, when a service channel of the digital broadcasting receiver is changed, the broadcasting data demodulator 120 demodulates digital broadcasting signals of at least two adjacent channels in a channel change direction and buffers and stores the signals in the broadcasting data storage 130, whereby data can be demodulated by rapidly reacting to a channel change instruction, compared to buffering of only a digital broadcasting signal of one adjacent channel in a channel change direction, and thus a channel can be quickly changed.

For example, when three service channels are received in one burst section, if it is assumed that a main channel in a current broadcasting mode is channel 9, a broadcasting signal of channel 10, which is a channel selected by the channel change, is received and displayed, and channels (channels 11 and 12) continuously adjacent to the one selected channel in a channel change direction are received and buffered. As described above, in one burst data section, data of two buffering service channels (channels 11 and 12) can be buffered in a channel change direction, whereby a channel change according to a channel change instruction can be more rapidly performed, compared to buffering of data of only one buffering service channel (channel 11) in a channel change direction.

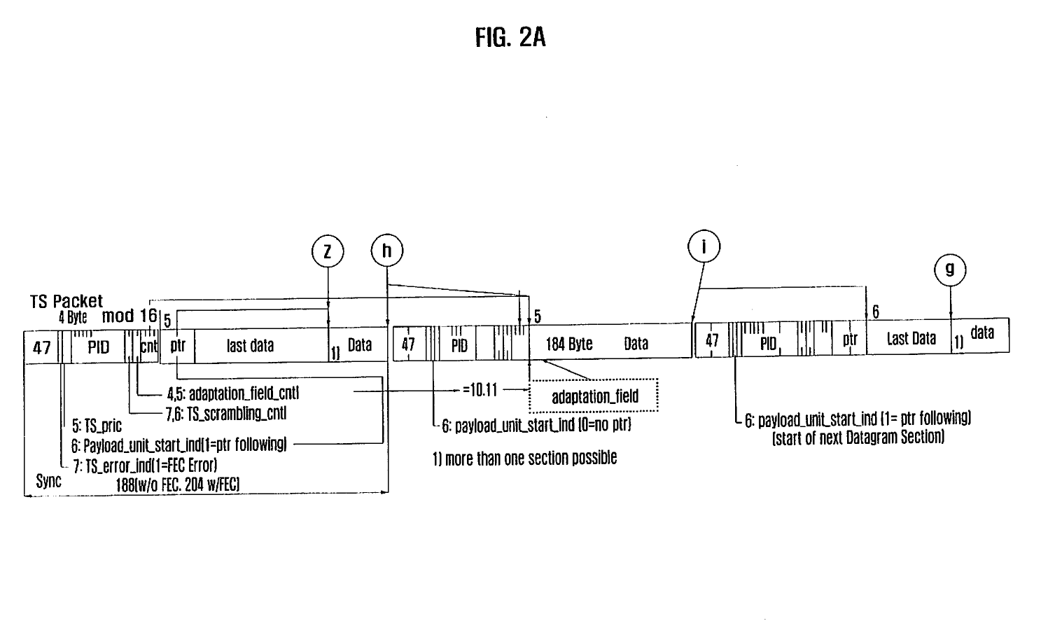

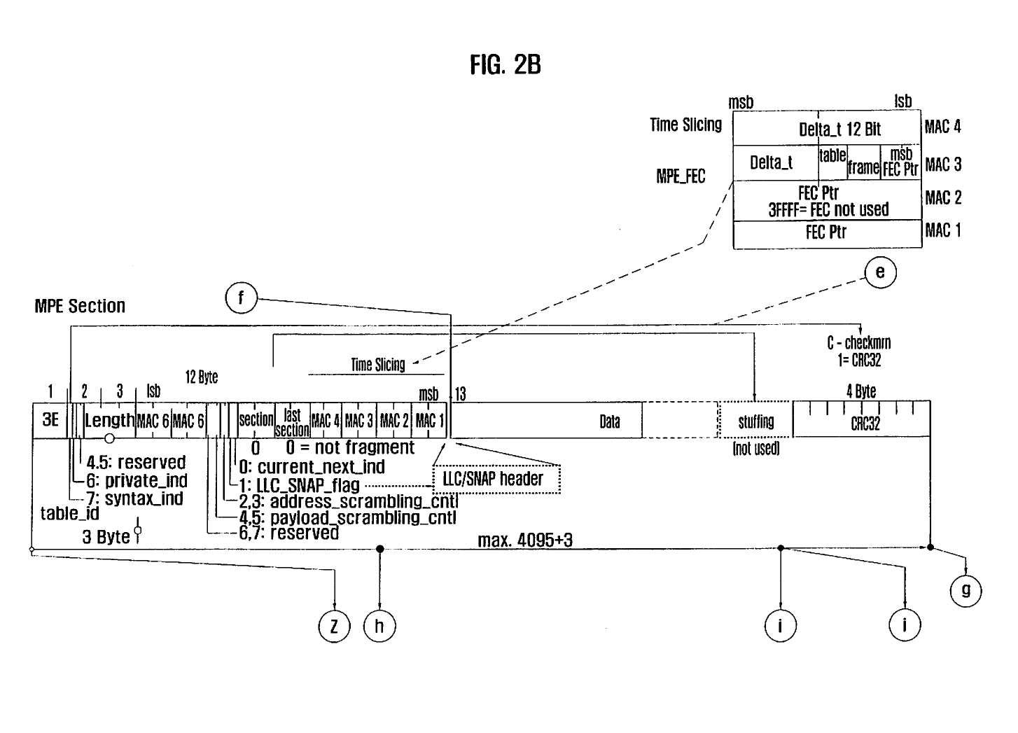

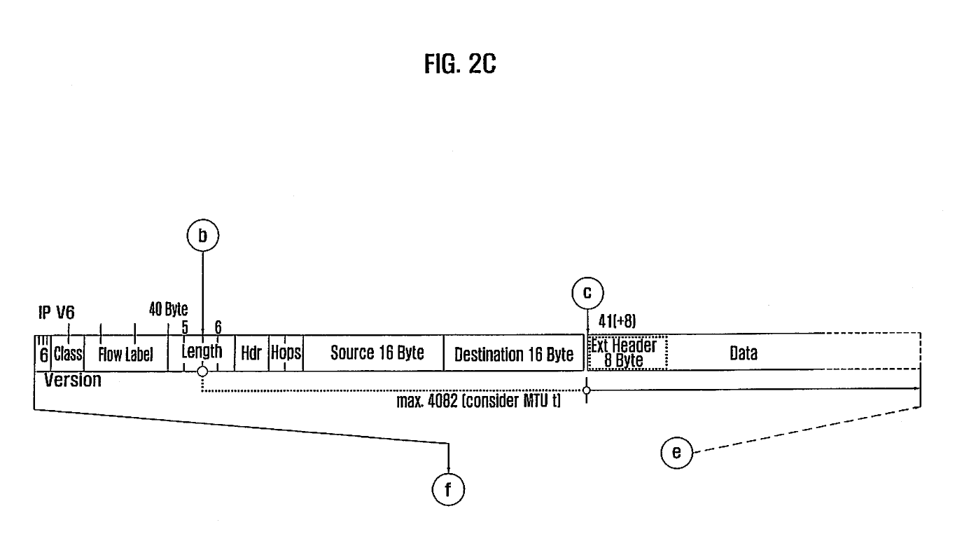

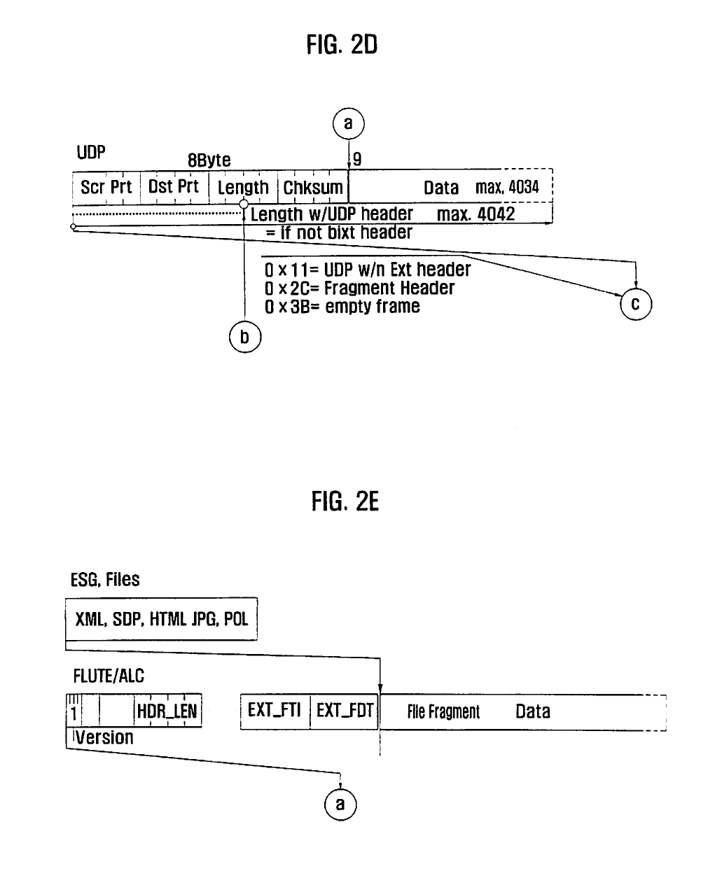

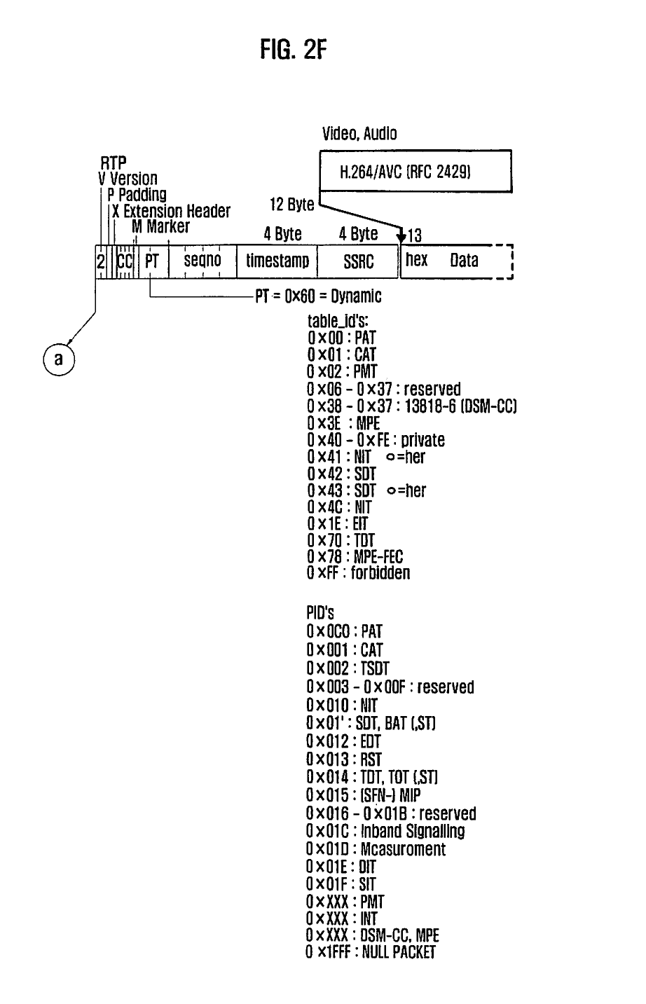

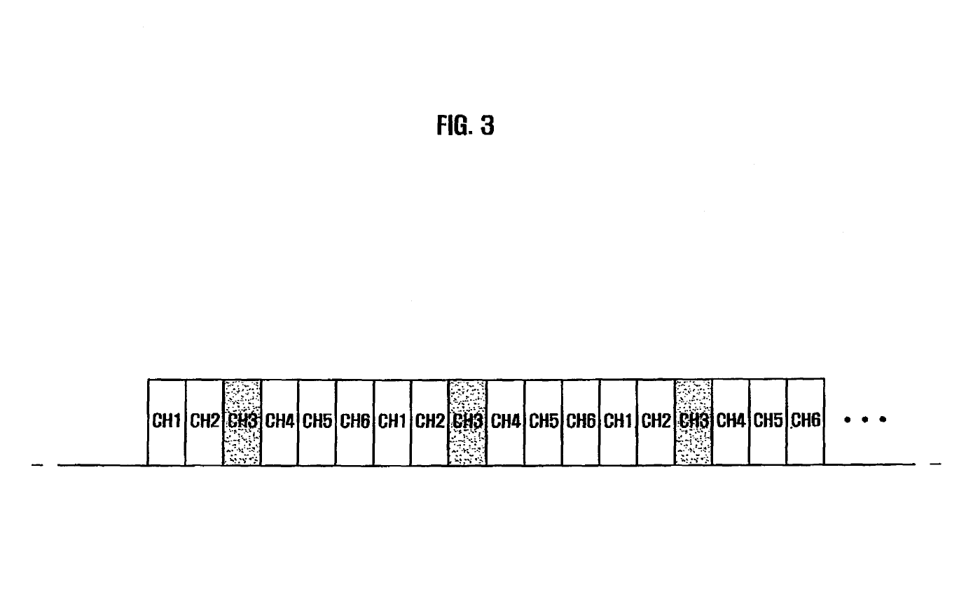

FIGS. 2A-F illustrate a data structure of a DVB-H type service channel received in a digital broadcasting receiver. DVB-H data has the data structure of FIGS. 2A to 2F.

In the DVB-H data structure of FIGS. 2A to 2F, the DVB-H data has an MPEG2-TS structure. Each TS packet of FIG. 2A has a size of 188 bytes and includes 4 byte size packet header and a payload size of 184 bytes. The packet header includes a packet sync and PID information. The PID can be used as information for identifying service channels and information for identifying a payload. FIG. 2B shows a configuration of an MPE section that can be loaded in the payload of FIG. 2A. The MPE section information may include table identification information (table_ID), information for correcting an error of received data (MPE-FEC), and information for time slicing of the received data. FIG. 2C shows a configuration of an IP datagram and shows an example using IPv6. The IP datagram includes IP version information (IPv6 or IPv4), an IP information (source IP address) of a transmitting side, and IP information (destination IP address) of a receiving side. FIG. 2D shows User Datagram Protocol (UDP) information and includes port addresses (Scr_Prt, Dst_Prt) of the transmitting and receiving sides. FIG. 2E shows a configuration of FLUTE/ALC and includes an Electronic Service Guide (ESG) and associated files. FIG. 2F shows a configuration of a Real-time Transport Protocol (RTP) and includes audio and video data.

FIG. 3 illustrates an example of a structure of service channel data using a time slicing technique. A DVB-H type digital broadcasting receiver uses a time slicing technique that reduces power consumption by supplying power only in a section in which broadcasting data are received and not supplying power in a section in which broadcasting data are not received.

FIG. 3 shows use of using six service channels (CH1 to CH6) in one physical channel, where a service channel selected by a user is CH3. In this case, a section in which data of CH3 are received is referred to as a burst time and the remaining sections (CH4, CH5, CH6, CH1, and CH2) are referred to as a burst off time. As shown in FIG. 3, data of each service channel are repeated and transmitted according to the determined order (here, an order of CH1 to CH6). When service channel data are transmitted using a time slicing technique, the digital broadcasting receiver can predict a burst time of a selected service channel and a burst time of unselected service channels. For example, as shown in FIG. 3, if it is assumed that data of six service channels are multiplexed and transmitted in one physical channel and a burst time of each service channel is 1 second, data of the selected service channel are received for 1 second every 6 seconds. In this case, because the burst time and burst off time can be determined, and a time slot in which the selected service channel is transmitted can also be determined (i.e. because a predetermined transmission order of service channel data can be identified), selected service channel data can be received by controlling time slicing in the burst time of the selected service channel. Further, time slicing of a buffering service channel according to the present invention can also be performed with the same method as in the time slicing control of the selected service channel. That is, if a buffering service channel is controlled with the same method as in the control of the selected service channel, the burst time of the buffering service channel can be determined.

Accordingly, utilizing the example provided in FIG. 3, if a service channel CH2 is selected while viewing a service channel CH3, broadcasting cannot be viewed until the burst of service channel CH2 appears, and in this case, an image screen cannot be displayed in the display unit of the digital broadcasting receiver. Accordingly, when a service channel is to be changed, the service channel cannot be changed until the burst of the service channel to be changed is acquired, whereby a service channel change time is lengthened and a cutting phenomenon in the screen display is generated. Accordingly, when a service channel is changed, in order to reduce a standby time until a next burst appears, data of a plurality of channels that are continuously adjacent to one side of a selected channel in a channel change direction are buffered, such that when the service channel is sequentially changed, the buffered data of the service channel newly selected during the sequential change are processed and played, until the next burst of the selected service channel is received and processed. Thereby, a service channel change time is shortened and discontinuance of a broadcasting screen displayed in a service channel change process can be prevented.

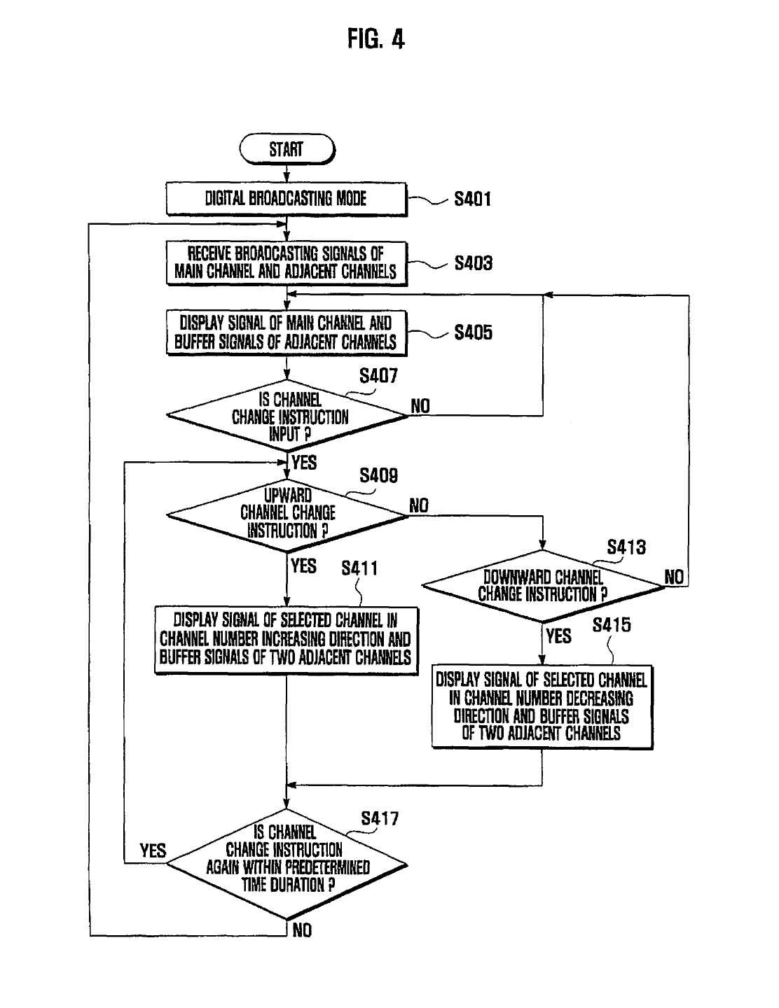

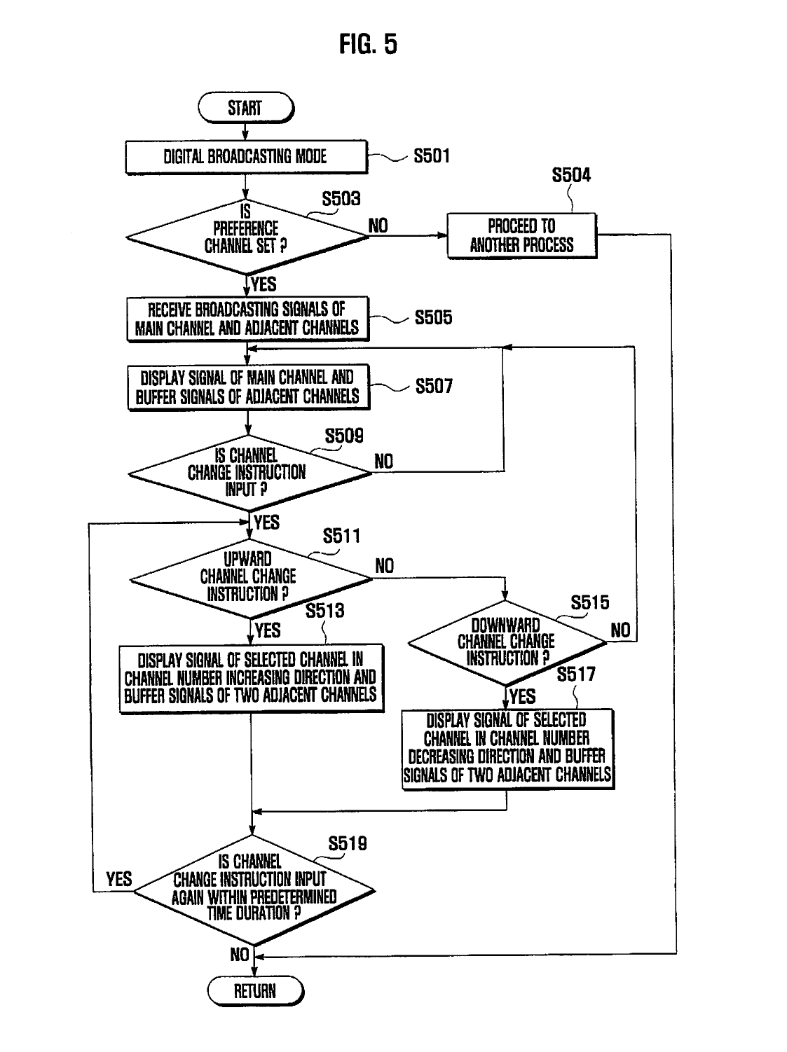

FIG. 4 is a flowchart illustrating a method of channel change of a digital broadcasting receiver according to an exemplary embodiment of the present invention. Referring to FIG. 4, in Step 401 the digital broadcasting receiver is in a digital broadcasting mode and, in Step 403, digital broadcasting signals of a main channel and channels adjacent to the main channel in an upper and lower direction of the main channel are received. The broadcasting data demodulator 120 demodulates and outputs a plurality of service channel signals included in a physical channel, i.e. broadcasting signals of a main channel and adjacent channels in an upper and lower direction of the main channel. The broadcasting data decoder 140 decodes the demodulated digital broadcasting data signal of the main channel, and outputs the decoded video and audio signals to the display unit 150 and speaker 155, respectively, for playing therein.

In Step 405, the display unit 150 of the digital broadcasting receiver displays the broadcasting signal of the main channel, and the broadcasting data storage 130 buffers and temporarily stores broadcasting signals of adjacent channels in an upper and lower direction of the main channel.

In Step 407, the controller 100 determines whether a channel change instruction is input during broadcast of the main channel. The channel change instruction is performed with a method of selecting service channels through inputting a channel up/down key or channel number key. The channel up/down key is a channel number change key for sequentially increasing or decreasing a channel number of the main channel.

If a channel change instruction is input, the controller 100 determines in Step 409 whether the channel change instruction is an upward channel change instruction, i.e. a channel change instruction in a channel number increasing direction. For a service channel selected using a channel number key, an upward channel change instruction is a channel change instruction selecting a channel in an increasing number direction of a current channel number.

If a channel number increasing instruction key is input, the broadcasting data demodulator 120 selects an upward adjacent channel of a main channel as a new main channel and demodulates digital broadcasting signals of a newly selected main channel (selected channel) and two adjacent channels continuously adjacent to one side of the selected channel in a channel number increasing direction, and the broadcasting data decoder 140 decodes and outputs data of the selected channel. In Step 411, the display unit 150 displays the digital broadcasting signal of the decoded selected channel, and the broadcasting data storage 130 buffers and temporarily stores the digital broadcasting signals of the two adjacent channels.

If the channel change instruction is determined not to be an upward channel change instruction in Step 409, the controller 100 determines in Step 413 whether the channel change instruction is a downward channel change instruction, i.e. a channel change instruction in a channel number decreasing direction. For a service channel selected using a channel number key, a downward channel change instruction is a channel change instruction selecting a channel in a decreasing number direction of a current channel number.

If a channel number decreasing instruction key is input, the broadcasting data demodulator 120 selects a downward adjacent channel of a main channel as a new main channel and demodulates digital broadcasting signals of a newly selected main channel (selected channel) and two adjacent channels continuously adjacent to one side of the selected channel in a channel number decreasing direction, and the broadcasting data decoder 140 decodes and outputs data of the selected channel. In Step 415, the display unit 150 displays the digital broadcasting signal of the decoded selected channel, and the broadcasting data storage 130 buffers and temporarily stores the digital broadcasting signals of the two adjacent channels.

In Step 417, the controller 100 determines whether a channel change instruction is input again within a predetermined time duration. For example, if a channel change instruction is input again within 1 second after the channel change according to the previous channel change instruction input, subsequent processes are repeated by returning to Step 409.

Accordingly, if a channel up/down key or channel number key is input again within a predetermined time duration after the channel change, digital broadcasting signals of two channels continuously adjacent to the newly changed channel in a channel change direction are buffered, whereby a channel change according to a channel change instruction can be performed more rapidly, compared to only buffering a broadcasting signal of one adjacent channel.

However, if a predetermined time duration (for example, 1 second) elapses without input of a further channel change instruction after the channel change according to the previous channel change instruction input, digital broadcasting signals of the main channel and two channels adjacent to both sides of the main channel are received by returning to Step 403.

FIG. 5 is a flowchart illustrating a method of channel change of a digital broadcasting receiver according to another embodiment of the present invention. Step 501 of FIG. 5 is similar to Step 401 of FIG. 4, and Steps 505 through 519 are similar to Steps 403 through 417 of FIG. 4.

The controller 100 determines whether a preference channel is set in Step 503. The preference channel is a channel frequently selected and preset by a user of a digital broadcasting receiver.

If a channel number increasing instruction key is input, the broadcasting data demodulator 120 selects an upward adjacent channel of a main channel as a new main channel and demodulates digital broadcasting signals of the newly selected main channel (selected channel) and two preference channels positioned at one side of the selected channel in a channel number increasing direction, and the broadcasting data decoder 140 decodes and outputs data of the selected channel. The display unit 150 displays the digital broadcasting signal of the decoded selected channel, and the broadcasting data storage 130 buffers and temporarily stores the digital broadcasting signals of the two preference channels in Step 513. The two preference channels are not necessarily adjacent to each other or adjacent to the main channel.

If a channel number decreasing instruction key is input, the broadcasting data demodulator 120 selects a downward adjacent channel of the main channel as a new main channel and demodulates digital broadcasting signals of the newly selected main channel (selected channel) and two preference channels positioned at one side of the selected channel in a channel number decreasing direction, and the broadcasting data decoder 140 decodes and outputs data of the selected channel in Step 517. The display unit 150 displays the digital broadcasting signal of the decoded selected channel, and the broadcasting data storage 130 buffers and temporarily stores the digital broadcasting signals of the two preference channels. The two preference channels are not necessarily adjacent to each other or adjacent to the main channel.

As described above, when a viewed service channel is changed in a conventional digital broadcasting receiver, the display of a broadcasting screen is discontinued while data of a changed service channel is received. In order to solve the above problem, in an embodiment of the present invention, when a channel is changed in a broadcasting mode, broadcasting signals of two channels continuously adjacent to a main channel in a channel change direction are buffered, whereby a broadcasting signal according to a channel change instruction speed can be more rapidly output, compared to f buffering one adjacent channel signal. Buffered adjacent channels can be set with a channel scan method. That is, when a user of the digital broadcasting receiver scans a channel, a method of scanning using a channel up/down key and a method of selecting service channels using a channel number key are generally used. Particularly, a method of setting buffered adjacent channels uses a method of setting a plurality of channels continuously adjacent to a selected channel in a channel change direction and buffering data of the plurality of adjacent channels, so that channel scan efficiency can be improved.

Further, according to the present invention, when a main channel is changed in a channel change direction within a predetermined time after a previous channel change in a digital broadcasting mode, broadcasting signals of a plurality of channels continuously adjacent to the main channel are buffered in a channel change direction of the main channel, whereby the main channel according to a channel change instruction can be more rapidly changed, compared to buffering a broadcasting signal of only one channel adjacent to the main channel in a channel change direction.

Although preferred embodiments of the present invention have been described in detail hereinabove, it should be clearly understood that many variations and modifications of the invention taught herein as understood by those skilled in the art fall within the spirit and scope of the invention, as defined by the appended claims.

What is claimed is:

1. A method changing channels of a digital broadcasting receiver, the method comprising:
receiving digital broadcasting signals of a main channel and of a plurality of channels continuously adjacent to one side of the main channel in a broadcasting mode; and
displaying the digital broadcasting signal of the main channel, and buffering and storing the digital broadcasting signals of the plurality of adjacent channels.

2. The method of claim 1, wherein two channels comprise the plurality of channels continuously adjacent to one side of the main channel.

3. A method of changing channels of a digital broadcasting receiver, the method comprising:
receiving digital broadcasting signals of a main channel and of channels adjacent to both sides of the main channel in a broadcasting mode;
displaying the digital broadcasting signal of the main channel on a screen of a display unit in the digital broadcasting receiver, and buffering and storing the digital broadcasting signals of the channels adjacent to both sides of the main channel;
determining whether a channel change instruction is input while the digital broadcasting signal of the main channel is displayed;
receiving, if a channel change instruction is input, digital broadcasting signals of a selected channel to which a channel is changed and of a plurality of channels adjacent to one side of the selected channel in a channel change direction; and
displaying the digital broadcasting signal of the selected channel on the display unit, and buffering and storing the digital broadcasting signals of the plurality of adjacent channels.

4. The method of claim 3, wherein the plurality of adjacent channels are two continuously adjacent channels in a channel number increasing direction of the selected channel when the channel change direction is the channel number increasing direction.

5. The method of claim 3, wherein the plurality of adjacent channels are two continuously adjacent channels in a channel number decreasing direction of the selected channel when the channel change direction is the channel number decreasing direction.

6. The method of claim 3, wherein the plurality of adjacent channels are two preferred channels positioned at one side of the selected channel in a channel number increasing direction of the selected channel when the channel change direction is the channel number increasing direction.

7. The method of claim 3, wherein the plurality of adjacent channels are two preferred channels positioned at one side of the selected channel in a channel number decreasing direction of the selected channel when the channel change direction is the channel number decreasing direction.

8. The method of claim 3, wherein if the channel change instruction is input within a predetermined time after a previous channel change instruction input, the plurality of adjacent channels is changed in the channel change direction.

9. The method of claim 3, further comprising:
receiving, if the channel change instruction is not input within a predetermined time duration of a previous channel instruction input, digital broadcasting signals of a selected channel and of channels adjacent to both sides of the selected channel, displaying the digital broadcasting signal of the selected channel on the screen of the display unit in the digital broadcasting receiver, and buffering and storing the digital broadcasting signals of the channels adjacent to both sides of the selected channel.

10. An apparatus for changing channels of a digital broadcasting receiver, the apparatus comprising:
a channel change determining unit for determining whether a channel change instruction is input in a broadcasting mode; and
a channel change controller for controlling reception of digital broadcasting signals of a selected channel according to a change channel and of a plurality of channels adjacent to one side of the selected channel in a channel change direction, display of the digital broadcasting signal of the selected channel on a screen of a display unit in the digital broadcasting receiver, and buffering of digital broadcasting signals of the plurality of adjacent channels.
